(19) United States
(12) Patent Application Publication
(10) Pub. No.: US 2025/0054653 A1
(43) Pub. Date: Feb. 13, 2025

(54) Optical window covered with a doped diamond electrode with active fouling removal functionality

(71) Applicant: THALES, Meudon (FR)

(72) Inventors: Raphaël GUILLEMET, PALAISEAU CEDEX (FR); Julie CHOLET, PALAISEAU CEDEX (FR); Doriane JUSSEY, PALAISEAU CEDEX (FR); Patrick GARABEDIAN, PALAISEAU CEDEX (FR)

(21) Appl. No.: 18/721,188

(22) PCT Filed: Dec. 20, 2022
(86) PCT No.: PCT/EP2022/086841

§ 371 Date: Jun. 17, 2024

(30) Foreign Application Priority Data
Dec. 21, 2021 (FR) FR2114085

(51) Int. Cl. H01B 1/06; G01P 5/26

(52) U.S. Cl. CPC H01B 1/06; G01P 5/26

(57) ABSTRACT

An optical window including on its surface two electrodes connected to a voltage generator in which at least one of the electrodes is a doped diamond electrode, the diamond being doped with an element that makes the diamond conductive.

### CROSS-REFERENCE TO RELATED APPLICATIONS

This application claims benefit under 35 USC § 371 of PCT Application N. PCT/EP2022/086841 entitled OPTICAL WINDOW COVERED WITH A DOPED DIAMOND ELECTRODE WITH ACTIVE FOULING REMOVAL FUNCTIONALITY, filed on Dec. 20, 2022 by inventors Raphaël Guillemet, Julie Cholet, Doriane Jussy and Patrick Garabedian. PCT Application No. PCT/EP2022/086841 claims priority of French Patent Application No. 21 14085, filed on Dec. 21, 2021.

### FIELD OF THE INVENTION

The present invention relates to an optical window comprising on the surface thereof, two electrodes connected to a voltage generator wherein at least one of the electrodes is a doped diamond electrode.

The invention further relates to a method for manufacturing such window.

### BACKGROUND OF THE INVENTION

The invention applies to the field of optical windows, with or without nanostructured surfaces.

Optical windows are optically transparent parts that allow light to be transmitted in a wide range of wavelengths from visible to medium and far infrared. Such windows are in direct contact with the atmosphere and in particular exposed to the elements. Thereby, the windows are often prone to fouling. In many applications and in particular for binoculars or cameras, it is desirable for the surface thereof to remain clean over time.

To prevent the accumulation of e.g. particles, residues or drops of water, on the surface of the optical windows, same were made superhydrophobic by nanostructuring and then functionalizing the surface thereof, e.g. by depositing polytetrafluoroethylene (PTFE) or a monofilm of a fluorocarbon polymer.

Nevertheless, such techniques do not prevent fouling, i.e. an adsorption on the surface of compounds such as micro-organisms, plants, algae or salt crystals, or even a stagnation on the surface of organic or inorganic compounds such as hydrocarbons

In order to clean the surface of the optical windows, only a manual or an automatic action using cloths, brushes proved to be effective. It is known from the prior art to apply a hydrogen plasma to optical windows in order to remove organic compounds and hence to clean the surface.

However, such cleaning processes are unsuitable for nanostructured surfaces. Moreover, such cleanings cannot be done during operational conditions and thus need to be carried out during dedicated maintenance operations.

Thereby, it is necessary to develop a solution for cleaning the optical window in an operational situation.

### SUMMARY OF THE DESCRIPTION

The goal of the present invention is to propose an optical window on which is deposited a doped diamond film serving to impart anti-fouling properties to said window

To this end, the subject matter of the invention is an optical window comprising on the surface thereof two electrodes connected to a voltage generator wherein at least one of the electrodes is a doped diamond electrode, the doping of the diamond doping being performed with a chemical element making the diamond conductive.

According to other advantageous aspects of the invention, the optical window comprises one or a plurality of the following features, taken individually or according to all technically possible combinations:
the second electrode is deposited at the periphery of the surface of said window and is separated from the doped diamond electrode.
the surface of said optical window is nanostructured or the doped diamond electrode is nanostructured.
the doped diamond electrode is doped at a concentration of 10¹⁹ to 10²¹ atoms/cm³, preferably 10¹⁹ to 10²⁰ atoms/cm³.
the doped diamond is doped with a chemical element to make the diamond conductive, more particularly doped with boron or nitrogen
the second electrode is a counter-electrode made of non-oxidizable metal, preferably doped diamond, gold, platinum or tungsten.
the optical window is made of diamond or transparent insulating material, more particularly germanium, silicon or glass.
   A further subject matter of the invention is a manufacturing method for an optical window according to the invention, comprising the following steps:
Deposition of a doped diamond film on the optical window
Deposition of the second electrode

The method may further comprise a preliminary step of nanostructuring the window prior to the step of deposition of doped diamond or comprising a step of nanostructuring the doped diamond film after the deposition of the doped diamond film.

In the embodiment according to which the optical window is nanostructured before the step of deposition of a doped diamond film on the optical window, the deposition of the diamond is a thin film deposition, i.e. a deposition with a thickness comprised between 100 and 200 nm. The method of measuring the thickness of the film is preferably a method during which the thicknesses are measured as a function of the deposition time. The thickness measurement can be carried out by any method known to a person skilled in the art, e.g. using a focused ion beam (FIB).

Preferably, the thin film deposition of the doped diamond takes place by microwave plasma chemical vapor deposition (MPCVD).

In the embodiment according to which the optical window is not nanostructured but the deposited doped diamond film is nanostructured, the doped diamond is deposited as a thick film, i.e. a film with a thickness comprised between 800 nm (for applications in the visible range) and 7 μm (for infrared applications), prior to the nanostructuring of the doped diamond.

Preferably, the doped diamond electrode is deposited in the center of the window surface. Advantageously, the doped diamond electrode is deposited on the surface of the optical window to be cleaned.

Preferably, a portion of the optical window surface in contact with the atmosphere separates the electrode from the counter-electrode.

Advantageously, the portion of the optical window surface in contact with the atmosphere makes it possible to isolate the electrode from the counter-electrode.

More particularly, the doped diamond electrode can cover up to 80% of the surface of the optical window.

Preferably, the counter-electrode is located at the periphery of the optical window, more particularly in the exclusion zone thereof.

Periphery or exclusion zone refers to the 5 mm wide circular area at the edge of the window.

A further subject matter of the present invention is the use, on the surface of an optical window, of a system of two electrodes, at least one of which is made of doped diamond, connected by a voltage generator, for the anti-fouling treatment of said window.

A further subject matter of the present invention is a device comprising at least one optical window, the device being a vision device such as visible or infrared sensors of cameras or binoculars, space instrumentation for terrestrial observation, surveillance systems for the maritime and terrestrial domains, and laser remote sensing (LIDARS for Light or Laser Imaging Detection and ranging), in particular anemometers for measuring flight parameters, and all the optronic sensors.

### BRIEF DESCRIPTION OF THE DRAWINGS

The features and advantages of the invention will appear upon reading the following description, given only as an example, but not limited to, and making reference to the enclosed drawings, wherein:

FIG. 1 is a schematic top view of a non-nanostructured optical window according to a first embodiment, the optical window comprising a doped diamond electrode and a counter-electrode;

FIG. 2 is a schematic lateral view of a nanostructured optical window according to a second embodiment of the invention; and

FIG. 3 is a schematic lateral view of an optical window comprising a nanostructured doped diamond electrode according to a third embodiment of the invention.

### DETAILED DESCRIPTION OF EMBODIMENTS

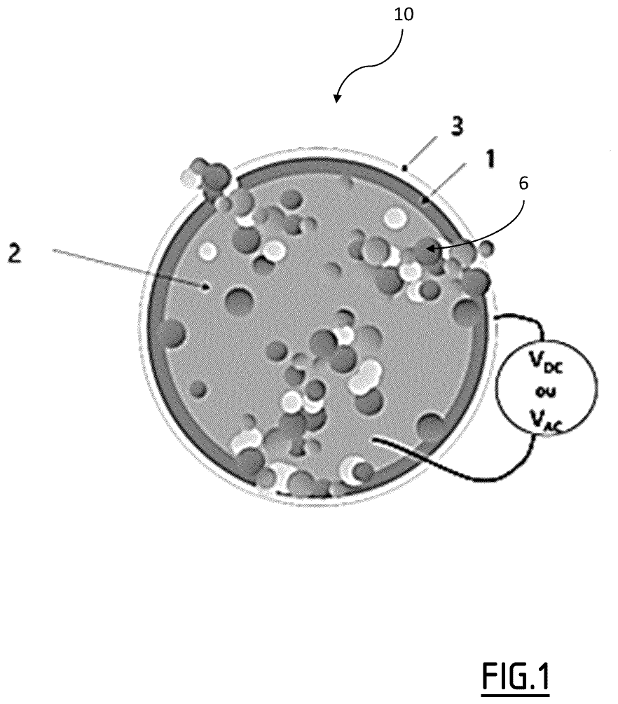

FIG. 1 shows an optical window 10 according to a first embodiment.

The optical window 10 comprises on the surface 1, two electrodes 2 and 3 hereinafter called electrode 2 and counter-electrode 3 and deposited in the form of films on the surface 1 of the optical window.

The film may be a thin film or a thick film. “Thin film” refers to a film with a thickness comprised between 100 and 200 nm, and the term “thick film” refers to a film with a thickness comprised between 800 nm and 7 μm.

The electrode 2 is made of doped diamond, the diamond being doped with a chemical element serving to make the diamond conductive.

More particularly, the diamond is doped with boron, nitrogen, more preferentially boron.

More particularly, the counter-electrode 3 is made of a non-oxidizable metal, preferably of doped diamond, gold, platinum, nickel or tungsten.

According to an advantageous example of the invention, the electrode 2 and the counter-electrode 3 are made of the same material, preferably of diamond doped with the same doping chemical element, preferably boron.

Advantageously, according to the invention, the electrode 2 and the counter-electrode 3 are both made of boron-doped diamond.

The electrode 2 and the counter-electrode 3 are connected together by a voltage generator.

More particularly, the voltage generator can supply a DC or AC voltage, preferably an AC voltage.

Without wanting to be bound by any theory, the defouling of the optical window 10 takes place at the doped diamond film. To this end, the optical window 10 has to be in contact with an electrolyte 6. “Electrolyte” refers to a substance, preferably a liquid substance, which is conductive due to the presence of mobile ions. The electrolyte may be of any type, in particular it may be water, the water may be clean water or an aqueous solution comprising pollutants, e.g. mud, etc. More particularly, the electrolyte 6 is water.

Without wanting to be bound by any theory, by applying a difference of potential between the electrode 2 and the counter-electrode 3 in the presence of the electrolyte 6, an electrical contact is created between the two electrodes. The electric current thereby generated leads to the electrolysis of the electrolyte 6, and more particularly the generation, in the case of water, of hydroxyl radicals OH—. The OH— radicals then oxidize the organic compounds adsorbed on the surface 1 of the optical window 10, into CO2. Thereby, the organic compounds are removed from the surface 1 of the window 10, which is cleaned.

The surface 1 of the optical window 10 may also be nanostructured according to a second embodiment.

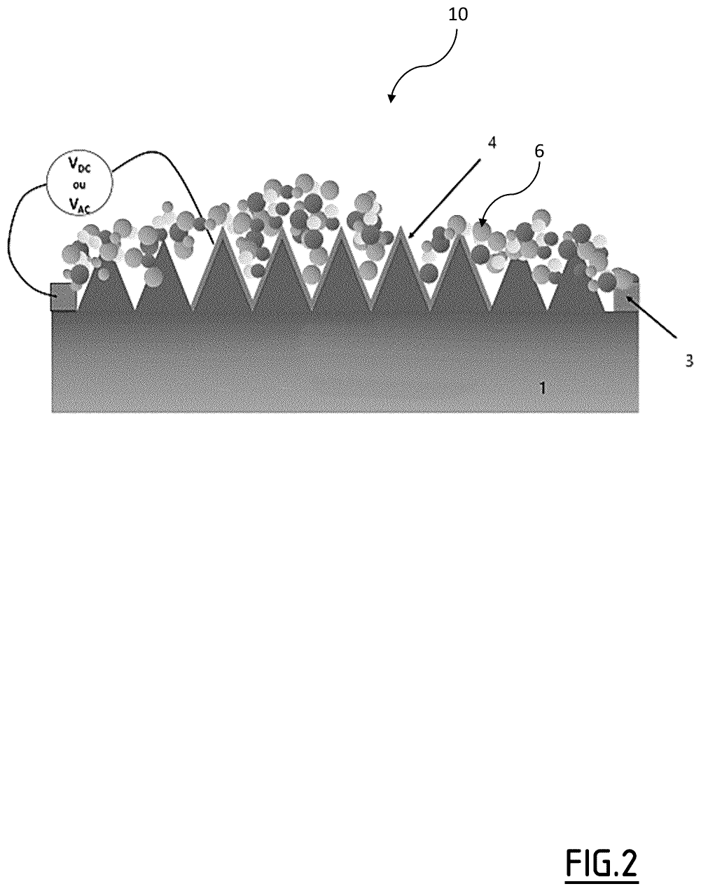

In the example of FIG. 2, the surface 1 of the optical window 10 is nanostructured and at least the nanostructured part is covered with a film, preferably a thin film, of doped diamond 4.

According to a preferred embodiment of the optical window 10 according to FIG. 2, the thin doped diamond film 4 has a thickness comprised between 100 and 200 nm, preferably a thickness comprised between 100 nm and 150 nm.

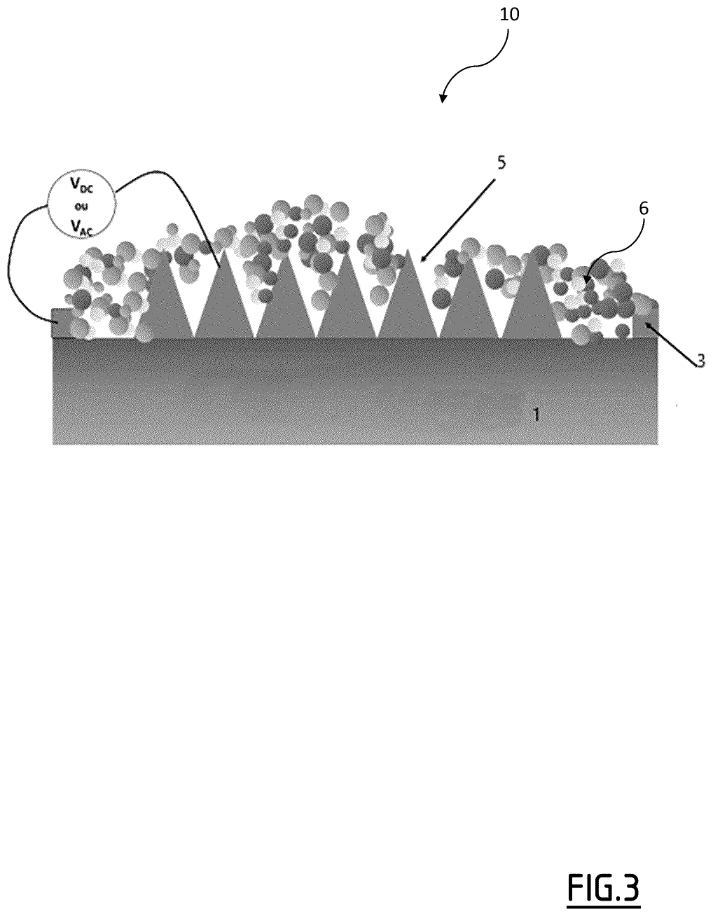

According to a third embodiment illustrated in FIG. 3, the doped diamond electrode is a nanostructured doped diamond electrode 5.

According to a preferred embodiment of the optical window according to FIG. 3, the film of the doped diamond electrode 5 is a thick film of thickness comprised between 800 nm for applications in the visible range and 7 μm for applications in the infrared range.

The film has a thickness of 800 nm for use in the visible, structured with a period of 200 nm, a thickness of 4 μm in the medium infrared (MWIR for Mid-wave infrared) structured with a period of 1 μm and a thickness of 7 μm in the far infrared (LWIR for long-wave infrared) structured with a period of 1.5 μm. The nanostructuring of the window thereby obtained is a sub-wavelength structuring and serves to prevent a diffraction phenomenon. Thereby, it is possible to obtain an antireflection property.

The method of manufacturing an optical window 10 according to the first embodiment will now be explained with reference to FIG. 1.

According to a first variant of the first embodiment, the electrode 2 and the counter-electrode 3 are both of the same nature and made of doped diamond.

A doped diamond film is deposited on all or part of the surface 1 of the optical window 10, preferably on the entire surface 1 of the optical window 10.

The doped diamond film can be deposited by any method known to a person skilled in the art, in particular by microwave plasma chemical vapor deposition (MPCVD) or by a high-pressure high-temperature method (HPHT), preferably by MPCVD.

Thereby, following the deposition, the diamond film covers the surface 1 of the optical window 10 uniformly and without any discontinuity.

The deposition step is followed by a lithography step followed by plasma etching. The two successive steps serve to trace a strip and then to dissociate the exclusion zone of the optical window 10 from the surface 1 of the optical window 10 to be cleaned. The doped diamond film located in the exclusion zone corresponds to the counter-electrode 3 and the doped diamond film located on the surface 1 of the optical window 10 to be cleaned corresponds to the electrode 2.

According to a second variant of the first embodiment, the electrode 2 and the counter-electrode 3 are of two different natures.

For the deposition of the counter-electrode, a resin, in particular a Shipley resin, is preferably deposited, then exposed and developed. The counter-electrode 3 is then deposited on the optical window 10 by cathode sputtering or evaporation. Such deposition step is followed by a step of removing the resin (or lift-off) using a solvent, such as acetone

The doped diamond electrode 2 is then deposited on the surface 1 of the optical window 10 to be cleaned.

The manufacturing method according to a second embodiment is also described with reference to FIG. 2.

According to a first variant of the second embodiment, the electrode 4 and the counter-electrode 3 are both of the same nature and made of doped diamond.

The first step is a step of nanostructuring the surface 1 of the optical window 10.

The nanostructuring is carried out by any method known to a person skilled in the art, and in particular by nano-printing. Other nanostructuring techniques known to a person skilled in the art may be used, such as plasma etching to obtain a non-periodic nanostructuring by means of a mask of (e.g. silica) nanoparticles deposited randomly on the surface to be nanostructured or by laser structuring technique (Jinguang Cai et al., Materials Horizons, 2015, volume 2, pages 37-53).

A second step consists in depositing the doped diamond on all or part, preferably all, of the surface 1 of the optical window 10, followed by lithography and then etching in order to obtain the electrode 4 and the counter-electrode 3.

Preferably, the etching is ion beam etching (IBE) using a beam of argon and oxygen ions.

According to a second variant, the electrode 4 and the counter-electrode 3 are of two different natures.

A first embodiment of the second variant consists of a step of nanostructuring the optical window 10 followed by the deposition of the film of the counter-electrode 3, preferably at the periphery of the window 10. A lithography and resin removal step is then carried out, followed by the deposition of the constituent doped diamond film 4 of the electrode.

Preferably, a second embodiment consists in depositing the counter-electrode 3, in nanostructuring the surface 1 of the optical window 10 to be cleaned and then in depositing a constituent doped diamond film 4 of the electrode.

The manufacturing method according to a third embodiment with reference to FIG. 3 is described thereafter.

According to a first variant of the third embodiment, the electrode 5 and the counter-electrode 3 are both of the same nature and made of doped diamond.

The first step of the variant consists in depositing a doped diamond film 5 on all or part of the window 10, preferably on the entire window 10. The doped diamond film 5 is then nanostructured. Finally, the lithography and etching step serve to dissociate the electrode 5 from the counter-electrode 3.

According to a second variant, the electrode 5 and the counter-electrode 3 are of two different natures.

According to a first embodiment, the doped diamond film 5 of the electrode 2 is deposited on the surface 1, then the film 5 is nanostructured. Finally, the counter-electrode 3 is deposited on the exclusion surface of the optical window 10.

According to a second embodiment, the counter-electrode 3 is deposited on the exclusion surface of the optical window 10, followed by the deposition of the doped diamond film 5. Finally, the nanostructuring of the film 5 is carried out.

In the different embodiments, the methods of nano-structuring, deposition of the doped diamond film and deposition of the electrode are as described hereinabove.

It can be understood as well that the present invention has a certain number of advantages.

First, the doped diamond electrode is transparent to the wavelength or wavelength range of use. Wavelength range means any range of wavelengths from visible to infrared. Thereby, said wavelength range is advantageous in the field of optical windows.

Diamond has excellent mechanical properties in terms of hardness, Young's modulus and toughness, which gives the optical window according to the invention advantageous mechanical robustness.

Doped diamond, made conductive by doping, has quasi-metallic conductivity, which makes same electro-magnetically compatible, which makes same advantageous in airborne applications.

Boron-doped diamond has a wide electrochemical reactivity that same imparts to the optical window wherein same is inserted.

Thereby, the optical window according to the invention has mechanical robustness, anti-fouling properties and anti-reflection properties.

Furthermore, the cleaning and defouling of the optical windows according to the invention can be done in an operational situation.

1. A device comprising an optical window comprising on the surface thereof first and second electrodes connected to a voltage generator wherein the first electrode is a doped diamond electrode, the doping of the diamond being carried out with a chemical element serving to make the diamond conductive, the device being chosen from visible or infrared sensors of cameras or binoculars, space instrumentation for terrestrial observation, surveillance systems for maritime and terrestrial domains, LIDARS and optronic sensors.

2. The device according to claim 1, wherein said second electrode is deposited peripherally on the surface of said optical window and is separated from aid doped diamond electrode.

3. The device according to claim 1, wherein the surface of said optical window is nanostructured or said doped diamond electrode is nanostructured.

4. The device according to claim 1, wherein the diamond is doped with boron.

5. The device according to claim 1 wherein sa second electrode is a counter-electrode of non-oxidizable metal.

6. The device according to claim 1 wherein the device is an anemometer for measuring flight parameters.

7. The device according to claim 5 wherein said second electrode is a counter-electrode of doped diamond, gold, platinum, nickel or tungsten.
